(19) United States
(12) Patent Application Publication
(10) Pub. No.: US 2024/0365433 A1
(43) Pub. Date: Oct. 31, 2024

(54) CITIZENS BROADBAND RADIO SERVICE DOMAIN PROXY CLUSTER FRAGMENTATION IDENTIFICATION AND HEALING

(71) Applicant: Telefonaktiebolaget LM Ericsson (publ), Stockholm (SE)

(72) Inventors: Simon RICHARDSON, Athlone (IE); Mayke NESPOLI, Athlone (IE)

(21) Appl. No.: 18/646,945

(22) Filed: Apr. 26, 2024

Related U.S. Application Data
(60) Provisional application No. 63/462,367, filed on Apr. 27, 2023.

(51) Int. Cl. H04W 76/38; H04W 76/18; H04W 76/19

(52) U.S. Cl. CPC H04W 76/38; H04W 76/18; H04W 76/19

(57) ABSTRACT

A method performed by a Citizens Broadband Radio Service, CBRS, domain proxy cluster instance for identifying and healing a cluster fragmentation scenario is disclosed. In one example, the method includes detecting, by the proxy cluster instance, that a transmit expiry time value for a supported radio device has expired or is about to expire; determining, by the proxy cluster instance, that communications with the supported radio device and a spectrum access system are available; utilizing an interface configured for conducting communications with the supported radio device to access a transmit expiry time value stored on the supported radio device; determining that an active proxy cluster instance belonging to the cluster has ceased communications with the supported radio device in response to detecting that a current transmit expiry time value stored on the supported radio has expired; and updating the supported radio device with a new transmit expiry time value.

### CROSS REFERENCE TO RELATED APPLICATIONS

This application claims priority to U.S. Provisional Patent application No. 63/462,367, filed on Apr. 27, 2023, the disclosure and content of which is incorporated by reference herein in its entirety.

### BACKGROUND

Citizens Broadband Radio Service (CBRS) is a dynamic shared spectrum band that is deployed in the United States (and its territories) and primarily used for midband 4G and 5G services. CBRS spectrum spans between 3550-3700 MHz and is authorized by the Federal Communications Commission (FCC) for commercial use and designed to enable efficient and effective use of the limited spectrum. A typical CBRS network includes a spectrum access system (SAS) (also known as “spectrum allocation service”), which manages the sharing of the CBRS spectrum among multiple users (including incumbent users), priority access licensees (PALs), and general authorized access (GAA) users. The SAS ensures that PALs have access to their assigned spectrum while also providing spectrum to GAA users when it is available. Additionally, the SAS communicates with environmental sensing capability (ESC) sensors, which detect the presence of incumbent users and inform the SAS of their location and frequency usage, allowing the SAS to protect the incumbents from harmful interference. Citizens Broadband Radio Service Devices (CBSDs) such as smartphones, cell towers, routers, and other equipment access the network using the CBRS spectrum.

Notably, a CBSD (or CBRS radio device) requests grants for CBRS service from a SAS either directly or via a Domain Proxy. For some radio devices operating in macro networks, a network component called CBRS Domain Coordinator (CBRS-DC) requests grants on behalf of the radio devices. The CBRS-DC is typically configured to subsequently update a supported radio device with a transmit expiry time associated with the requested grant. This process of obtaining grants and/or transmit expiry times must be repeated every few minutes if there is to be no break in the service and/or transmission.

### SUMMARY

A method performed by a Citizens Broadband Radio Service, CBRS, domain proxy cluster instance for identifying and healing a cluster fragmentation scenario is disclosed. In one example, the method includes detecting (601), by the CBRS domain proxy cluster instance, that a transmit expiry time value for a supported radio device has expired or is about to expire, wherein the CBRS domain proxy cluster instance belongs to a cluster of CBRS domain proxy cluster instances. The method also includes determining (602), by the CBRS domain proxy cluster instance, that communications with each of the supported radio device and a spectrum access system, SAS, is available. The method further includes utilizing (604) an interface configured for conducting communications with the supported radio device to access a transmit expiry time value stored on the supported radio device. The method also includes determining (605) that an active CBRS domain proxy cluster instance belonging to the cluster has ceased communications with the supported radio device in response to detecting that the current transmit expiry time value stored on the supported radio has expired and updating (606) the supported radio device with a new transmit expiry time value.

Certain embodiments may provide one or more of the following technical advantages. Various embodiments described herein can achieve improved reliability of CBRS domain controllers and the associated CBRS services supported within commercial networks. In particular, by improving the reliability of domain proxy cluster instances operating within a CBRS domain controller, a cluster fragmentation scenario can be identified promptly and addressed in an effective manner. Accordingly, network outages and failures related to the cluster fragmentation scenarios can be avoided or largely eliminated.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a block diagram of an example CBRS operating environment for the various embodiments;

FIG. 2 is a block diagram depicting signaling messages transmitted in a CBRS network during normal operation;

FIG. 3 is a block diagram depicting signaling messages transmitted in a CBRS network when an active CBRS domain proxy cluster instance has failed;

FIG. 4 is a block diagram depicting signaling messages transmitted in a CBRS network when a standby CBRS domain proxy cluster instance has failed;

FIG. 5 is a block diagram depicting signaling messages transmitted in a CBRS network when a split brain fragmentation scenario occurs according to some embodiments;

FIG. 6 is a flow chart illustrating the detection of a split brain fragmentation scenario according to some embodiments;

FIG. 7 is a block diagram of a control system according to some embodiments;

FIG. 8 is a block diagram of a communication system in accordance with some embodiments;

FIG. 9 is a block diagram of a user equipment in accordance with some embodiments;

FIG. 10 is a block diagram of a network node in accordance with some embodiments; and

FIG. 11 is a block diagram of a virtualization environment in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

There currently exist certain challenges in the operation of a CBRS network. In some instances, a CBRS-DC is executed on a number of platforms and can be implemented as multiple containers grouped together to form a cluster (e.g., a collection or group of domain proxy cluster instances). In some embodiments, a CBRS-DC cluster may include an active CBRS domain proxy cluster instance and at least one standby CBRS domain proxy cluster instance. More generally, a cluster may include a grouping of cluster instances comprising an active domain proxy cluster instance and at least one standby domain proxy cluster instance. As such, the possibility of fragmentation of the cluster—a so-called “split brain” scenario—exists. Notably, this cluster fragmentation (e.g., loss of communication between the active domain proxy cluster instance and the standby domain proxy cluster instance(s)) can cause problems when the SAS needs the grants to be altered and/or when the fragmentation is ultimately resolved.

Specifically, an isolated cluster member (e.g., a domain proxy cluster instance that has lost communications with the other domain proxy cluster instances/members in the cluster), provided it can communicate with both the SAS and the radio device, does not know if it should continue to renew grants on behalf of a supported radio device or not. If the other cluster members are no longer running, failure on the part of the isolated cluster member to poll or renew grants will result in network outage. However, if the other clusters members are still operating, the renewal of grants by the isolated cluster member without notifying the other cluster members will cause the SAS to reject the grants and possibly the registration, thereby causing a network outage. This split brain problem has been identified in both the CBRS-DC and in independently developed CBRS domain proxy cluster instances.

The problem of detecting, operating during, and recovering from the “split brain” fragmentation scenario is a challenge, since it is hard for a cluster member to identify what has happened to a cluster as a whole. Many fault scenarios can cause a member of the cluster to lose communication with the other cluster members, and the behavior should be different depending on the fault condition.

Embodiments of the disclosed subject matter can be configured to rely on the ability to communicate with the SAS and with the radio devices. In contrast, any cluster member that cannot communicate with the SAS or a supported radio device should cease operations and do nothing. If a cluster member can communicate with the SAS and the radio device, the cluster member should check the transmit expiry time value (e.g., on the radio device) to determine if another cluster member has previously updated it. If another cluster member has updated the radio device's transmit expiry time value, then the inquiring cluster member should continue its monitoring tasks. If the radio device's transmit expiry time value has not been updated, then the inquiring cluster member should take measures to update it.

When the cluster re-forms, the individual members should only share information about radio devices that are being supported/updated (by each respective cluster member) and should allow other cluster members to provide information about the radio devices that this member is monitoring.

Notably, the disclosed subject matter utilizes the ability of a domain proxy cluster instance to communicate with both the SAS and a radio device to identify when a split brain scenario has occurred and act accordingly. For example, the disclosed subject matter allows for the monitoring of the behavior of other cluster members by observing when transmit expiry times have been updated. The disclosed subject matter also allows a standby domain proxy cluster instance to update transmit expiry time values when no other cluster member is able to do so (e.g., an active cluster member fails). Moreover, the disclosed subject matter facilitates the sharing of radio device information upon recovering from the split brain scenario. Specifically, only information related to the radio devices that a cluster member (e.g., a domain proxy cluster instance) is actually updating is ultimately shared with the other cluster members when the split brain fragmentation problem is corrected.

The following figures illustrate an example CBRS system and the signaling communications conducted among the CBRS domain proxy cluster instances (e.g., cluster members) of a CBRS domain controller prior to and during the detection of a split brain fragmentation scenario. While the following figures describe the cluster members as domain proxy cluster instances in a CBRS system, other network elements and network systems can utilize the described methods and processes without departing from the disclosed subject matter.

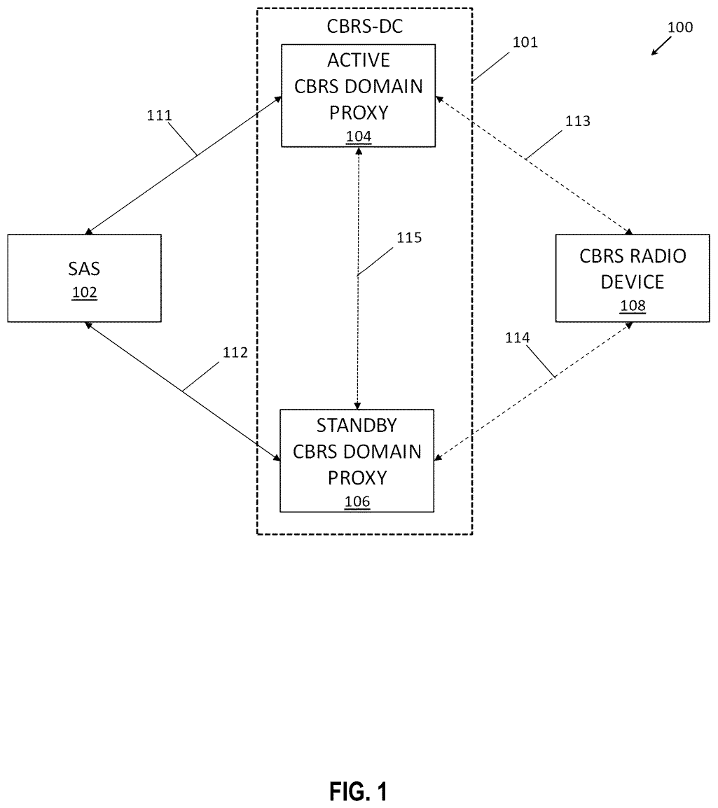

FIG. 1 illustrates an example CBRS network 100 that includes a SAS 102, a CBRS domain coordinator 101, and a CBRS radio device 108. Although FIG. 1 depicts a CBRS network, any other type of network including a domain controller, a spectrum control element, and one or more supported radio devices can be utilized in the manner described herein without departing from the scope of the disclosed subject matter. Notably, the SAS 102 is a type of spectrum control element that is responsible for managing the spectrum allocation and interference mitigation in the CBRS network. The SAS 102 determines the available spectrum resources and allocates them to authorized CBRS radio devices on a priority basis. Moreover, the SAS 102 ensures that the CBRS network 100 is secure by enforcing access control policies (e.g., issuing grants and transmit expiry time values to CBRS radio devices) and ensuring that only authorized users can access the network. As used herein, a CBRS radio device includes any wireless communications device that is capable of operating on the 3550-3700 MHz frequency bands for a variety of purposes, such as providing wireless broadband services, IoT (Internet of Things) connectivity, and mission-critical communications to authorized users. Notably, the CBRS radio device 108 is configured to communicate with the SAS 102, either directly or via domain coordinator 101, to obtain authorization (e.g., grants and time expiry time values) to use the available spectrum resources.

As shown in FIG. 1, the CBRS domain coordinator 101 functions as a CBRS domain proxy that includes a pair of cluster member instances. Although FIG. 1 only depicts one domain coordinator 101, it is understood that the network may deploy a plurality of domain coordinators to serve a plurality of supported radio devices. In such a scenario, the network's selection of which specific CBRS DC instance serves a particular radio device can be controlled by various dynamic algorithms. Notably, a first cluster member instance is configured to function as an active CBRS domain proxy cluster instance 104 and the second cluster member instance is configured to function as a standby CBRS domain proxy cluster instance 106. While FIG. 1 depicts only two cluster member instances, additional instances may be deployed within domain coordinator 101 without departing from the scope of the disclosed subject matter. As described herein, one cluster member instance will always be designated as an active instance for supporting a particular CBRS radio device, while the other remaining instances will be designated to function in a standby role. More specifically, for each CBRS radio device 108 that is supported by the domain coordinator 101, there should always be one designated active domain proxy cluster instance. Likewise, one or more of the remaining cluster member instances will be configured to serve as standby instances for supporting the CBRS radio device. It should also be noted that the instance that is designated as the active domain proxy cluster instance for a particular CBRS radio device may be designated to simultaneously serve as a standby domain proxy cluster instance for another CBRS radio device (not shown) supported by the domain coordinator 101.

As illustrated in FIG. 1, each of the active domain proxy cluster instance 104 and standby domain proxy cluster instance 106 has a communication interface (e.g., interfaces 111-112) that permits communication with the SAS 102. In some embodiments, these communication interfaces to the SAS 102 conform to the Wireless Innovation Forum Standards for the SAS-CBSD protocol. In addition, each of the active domain proxy cluster instance 104 and the standby domain proxy cluster instance 106 may include an interface (e.g., interfaces 113-114) used to communicate with the CBRS radio device 108. Each of these domain proxy cluster instances may use its interface with the radio device 108 to access and read a transmit expiry time value that is currently set and/or stored on the radio device. Further, the interface can also be used by the domain proxy cluster instance(s) to update the transmit expiry time value on the supported radio device.

Further, each of the active domain proxy cluster instance 104 and the standby domain proxy cluster instance(s) 106 can be configured with an interface (e.g., interface 115) that allows the active domain proxy cluster instance 104 to update the other one or more standby domain proxy cluster instances 106 with the transmit expiry time value that is obtained from the SAS 102 and/or last set by the active domain proxy cluster instance 104 on the radio device 108.

It should be noted that any one of interfaces 111-115 may fail for any number of reasons. Moreover, a CBRS domain proxy cluster instance that is unable to communicate with the SAS 102 or the radio device 108 will be able to detect that either i) the interface/communication link has failed (e.g., if one or more of interfaces 111-114 has failed) or ii) the SAS or radio device has failed, but will not be able to differentiate between the failure of the interface vs. the failure of device/SAS. Similarly and more importantly, a CBRS domain proxy cluster instance that has lost communication with the other domain proxy cluster instances (e.g., interface 115 has failed and/or is lost) currently has no way to determine whether it is the only domain proxy cluster instance that is operational or if it has merely lost communication with the other domain proxy cluster instances. This problematic scenario can potentially lead to more serious network problems as discussed herein.

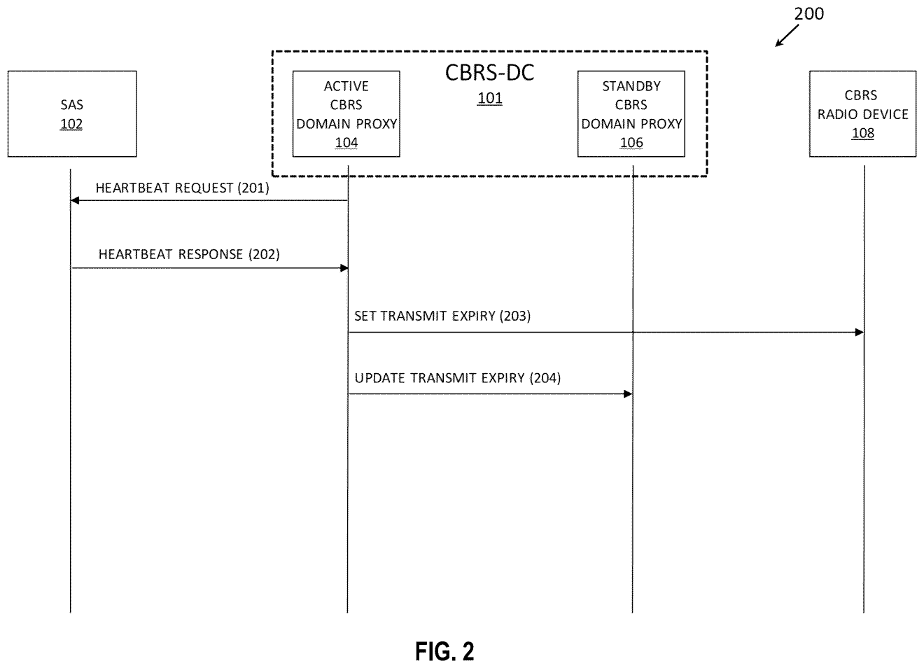

FIG. 2 shows an example signaling flow diagram 200 that includes the network elements referenced in FIG. 1. More specifically, FIG. 2 illustrates the normal operation of the domain coordinator 101. The signaling depicted in FIG. 2 occurs after all grants have been requested and the CBRS radio device 108 has been configured accordingly. In FIG. 2, a CBRS heartbeat polling mechanism is used to update the transmit expiry time value on the CBRS radio device 108, thereby permitting its continued transmission over the network. For example, the active CBRS domain proxy cluster instance 104 may send a heartbeat request 201 to the SAS 102. In response to receiving the request 201, the SAS 102 generates and sends a heartbeat response 202 that is received by the active domain proxy cluster instance 104. Notably, the heartbeat response 202 includes a new transmit expiry time value corresponding to CBRS radio device 108. After receiving the heartbeat response 202, the active CBRS domain proxy cluster instance 104 accesses the CBRS radio device 108 and writes and/or sets the transmit expiry time value via signal 203. Moreover, the new transmit expiry time value is also sent by the active CBRS domain proxy cluster instance 104 to the standby CBRS domain proxy cluster instances (e.g., standby domain proxy cluster instance 106) via a signaling message 204 (via interface 115 in FIG. 1). Once the standby CBRS domain proxy cluster instance(s) receives the new transmit expiry time value, the standby domain proxy cluster instance(s) is then permitted to utilize the transmit expiry time value to monitor the progress of the active domain proxy cluster instance 104. For example, a standby domain proxy cluster instance may be triggered to monitor and/or query the CBRS radio device 108 if its most recently recorded (e.g., locally stored) transmit expiry time value for radio device 108 expired. In many cases, a standby domain proxy cluster instance is configured to detect and/or notice that a stored transmit expiry time value has not been updated prior to its expiration, thereby allowing sufficient time for the standby domain proxy cluster instance to perform the update procedure and prevent any interruption in service.

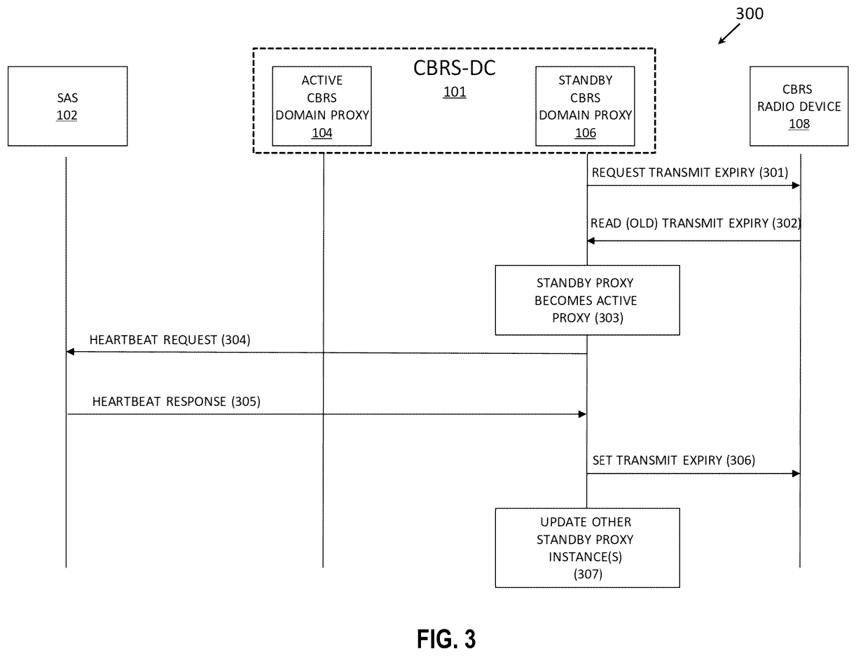

FIG. 3 shows an example signaling flow diagram 300 that includes the network elements referenced in FIG. 1. More specifically, FIG. 3 illustrates a failure scenario pertaining to the active CBRS domain proxy cluster instance 104. In some embodiments, an active instance failure may be attributed to i) the active CBRS domain proxy cluster instance 104 failing itself, or ii) the loss of communication between the active CBRS domain proxy cluster instance 104 with either the SAS 102 or the CBRS radio device 108 (or both). In each of these scenarios, the active CBRS domain proxy cluster instance 104 will not be able to update the transmit expiry time value on the CBRS radio device 108. Further, the standby CBRS domain proxy cluster instance 106 will not receive a new updated value of the transmit expiry time from the failed active domain proxy cluster instance 104. In this situation, the standby CBRS domain proxy cluster instance 106 will be triggered to send a transmit expiry time request 301 to radio device 108 in order to access and read (e.g., message 302) the transmit expiry time value directly from the CBRS radio device 108. If the transmit expiry time value that is obtained and/or read by the standby CBRS domain proxy cluster instance 106 is determined (block 303) by standby domain proxy cluster instance 106 to be old and/or expired, the standby CBRS domain proxy cluster instance 106 is triggered (e.g., designates itself) to become the new active domain proxy cluster instance.

Moreover, the CBRS domain proxy cluster instance 106 (now functioning as the new active domain proxy cluster instance) may subsequently request a new transmit expiry time value from the SAS 102 by sending a heartbeat request 304. In response to receiving the request 304, the SAS 102 generates and sends a heartbeat response 305 that is received by the new active domain proxy cluster instance (i.e., former standby domain proxy cluster instance 106). Notably, the heartbeat response 202 includes a new transmit expiry time value corresponding to CBRS radio device 108. The new active domain proxy cluster instance then sends the new transmit expiry time value to radio device 108 for updating and storage. Accordingly, the radio device 108 is able to continue to utilize the CBRS service and its transmissions. In some embodiments, the new active domain proxy cluster instance may update (see block 307) one or more other standby CBRS standby instances (not shown) with the recently obtained new transmit expiry time value associated with radio device 108.

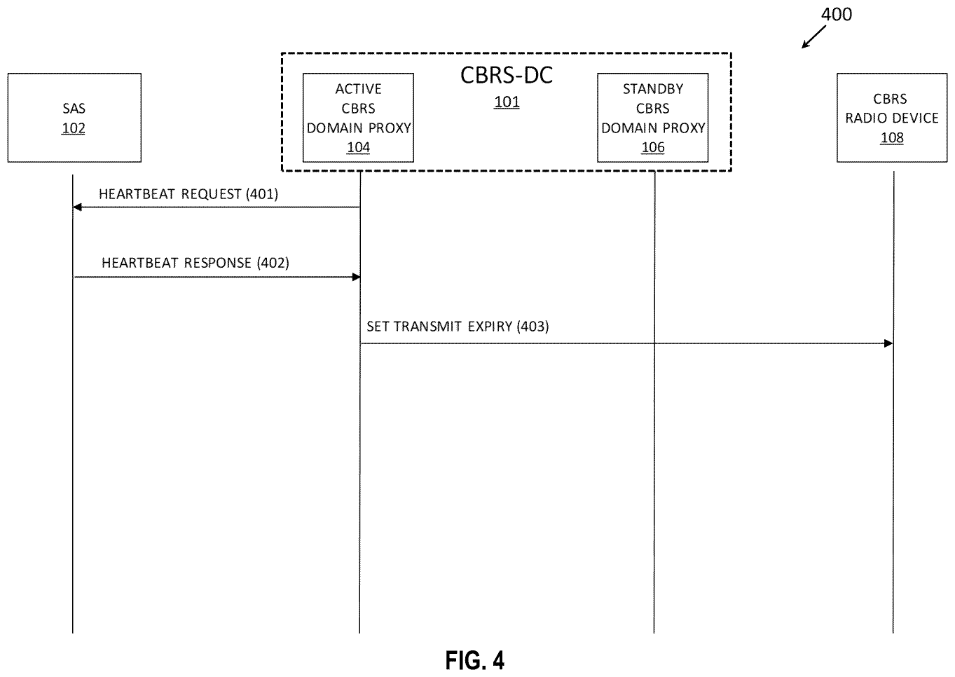

FIG. 4 shows an example signaling flow diagram 400 that includes the network elements referenced in FIG. 1. More specifically, FIG. 4 illustrates an example scenario pertaining to a failure of a standby CBRS domain proxy cluster instance. For example, standby CBRS domain proxy cluster instance 106 has failed and is no longer operating. As shown in FIG. 4, active CBRS domain proxy cluster instance 104 sends a heartbeat request 401 to the SAS 102. In response to receiving the request 401, the SAS 102 generates and sends a heartbeat response 402 that is received by the active domain proxy cluster instance 104. Notably, the heartbeat response 402 includes a new transmit expiry time value associated with CBRS radio device 108. After receiving the heartbeat response 402, active CBRS domain proxy cluster instance 104 accesses CBRS radio device 108 and writes and/or updates the transmit expiry time value via signal 403. However, the active CBRS domain proxy cluster instance 104 is unable to update the standby CBRS domain proxy cluster instance 106 with the new transmit expiry time value since the standby domain proxy cluster instance 106 has a failed and/or is no longer operational.

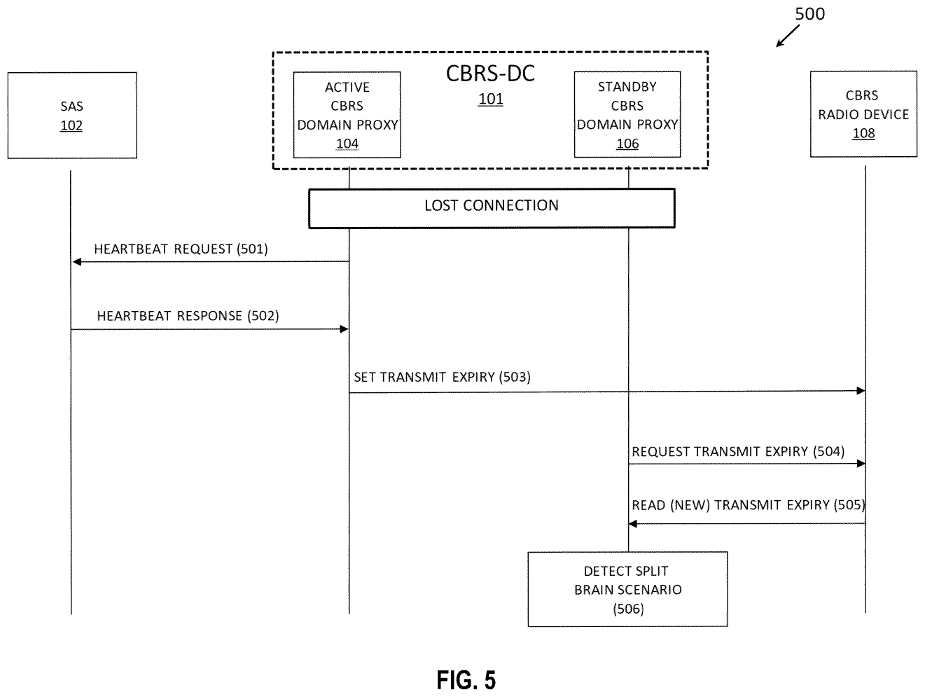

FIG. 5 shows an example signaling flow diagram 500 that includes the network elements referenced in FIG. 1. More specifically, FIG. 5 illustrates an example scenario where the active and standby domain proxy cluster instances are both operating but are unable to communicate with each other. As used herein, this occurrence may be referred to as a cluster fragmentation scenario or a “split brain” scenario. In this example shown in FIG. 5, the active CBRS domain proxy cluster instance 104 is able to update the transmit expiry time value on the CBRS radio device 108, but is unable to update the standby CBRS domain proxy cluster instance(s) with the new transmit expiry time value. Notably, since the standby domain proxy cluster instance(s) are not updated with the value, the standby domain proxy cluster instance(s) is configured to obtain and/or read the transmit expiry time value from the CBRS radio device 108 and subsequently able to detect the split brain fragmentation scenario in the manner described below.

For example, in signaling flow diagram 500, the standby CBRS domain proxy cluster instance 106 is still operating but has lost communication and/or its interface with active CBRS domain proxy cluster instance 104 (i.e., lost the interface 115 in FIG. 1). As shown in FIG. 5, the active CBRS domain proxy cluster instance 104 sends a heartbeat request 501 to the SAS 102. In response to receiving the request 501, the SAS 102 generates and sends a heartbeat response 502 that is received by the active domain proxy cluster instance 104. Notably, the heartbeat response 502 includes the new transmit expiry time value associated with the CBRS radio device 108. After receiving the heartbeat response 502, the active CBRS domain proxy cluster instance 104 accesses the CBRS radio device 108 and writes and/or updates the transmit expiry value via signal 503. However, the active CBRS domain proxy cluster instance 104 is unable to update standby CBRS domain proxy cluster instance 106 with the new transmit expiry time value since the standby domain proxy cluster instance 106 has a failed interface and/or lost its connection with the active CBRS domain proxy cluster instance 104.

Since the standby CBRS domain proxy cluster instance 106 did not receive the new updated transmit expiry time value, standby domain proxy cluster instance 106 then is triggered to monitor the CBRS radio device 108 in accordance with its standby role requirements. In particular, the standby CBRS domain proxy cluster instance 106 sends a transmit expiry time request message 504 to the CBRS radio device 108. In some embodiments, the standby CBRS domain proxy cluster instance 106 is configured to read the transmit expiry time value directly from the CBRS radio device 108 (see message 505).

Because the transmit expiry time value obtained from the radio device 108 is determined by the standby domain proxy cluster instance 106 to have already been updated (i.e., by active CBRS domain proxy cluster instance 104 via message 503), the standby CBRS domain proxy cluster instance 106 detects (see block 506) that a split brain fragmentation scenario has occurred because the transmit expiry time value maintained at the CBRS radio device 108 differs from the (older/expired) transmit expiry time value stored at the standby CBRS domain proxy cluster instance 106. More specifically, the standby CBRS domain proxy cluster instance 106 detects that the interface with the active CBRS domain proxy cluster instance 104 has failed or has been lost since i) the transmit expiry time value has already been updated at the CBRS radio device 108, and ii) the standby domain proxy cluster instance 106 did not receive and store the updated transmit expiry time value from the active CBRS domain proxy cluster instance 104. In this scenario, the standby domain proxy cluster instance 106 recognizes and/or detects the occurrence of the “split brain” scenario in block 506 and does not become an active domain proxy cluster instance. More specifically, because the transmit expiry time value has been updated at the radio device 108, the standby domain proxy cluster instance(s) know that the active CBRS domain proxy cluster instance 104 is still operational and thereby takes no further action. Notably, the active CBRS domain proxy cluster instance 104 will continue to update the radio device 108 with transmit expiry time values such that the transmission(s) associated with the radio device 108 is permitted to continue on the CBRS network. In some embodiments, the standby domain proxy cluster instance 106 may be configured to verify the split brain fragmentation scenario by confirming that its communications with each of the CBRS radio device 108 and the SAS 102 is still possible (e.g., using heartbeat or ping request messages).

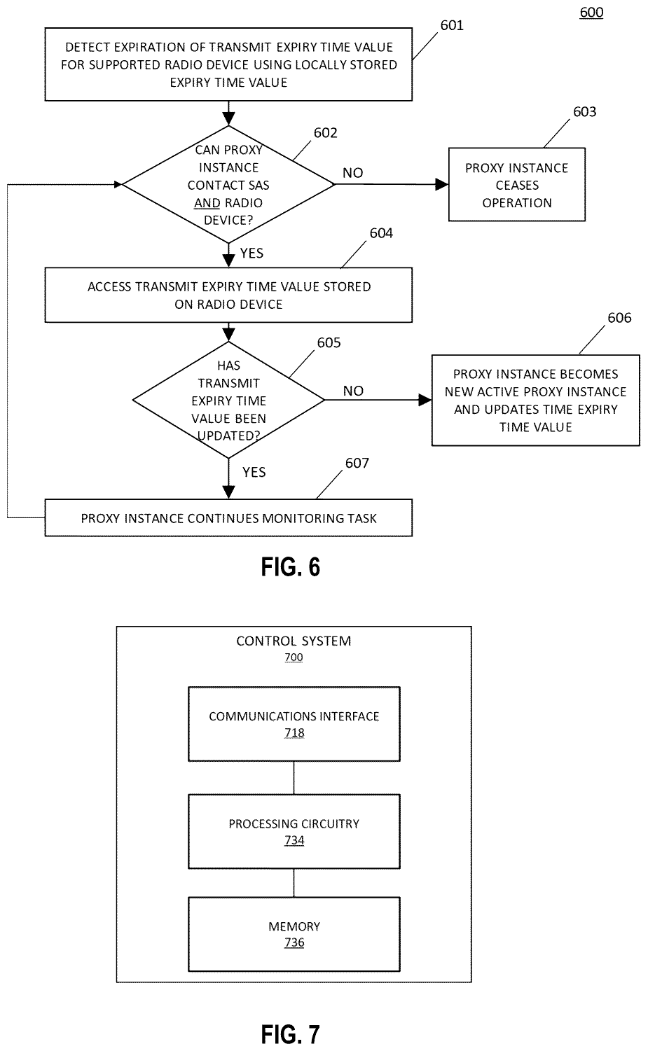

FIG. 6 is a flow chart of a method and/or process 600 executed by a CBRS domain proxy cluster instance when the domain proxy cluster instance loses communication with the other domain proxy cluster instances (e.g., a standby domain proxy cluster instance losing communication with an active domain proxy cluster instance) in its instance cluster. In some embodiments, process 600 may be a software algorithm that is stored in memory and executed by one or more processors (e.g., processing circuitry) of a network node hosting the domain proxy cluster instance. In some embodiments, the network node hosts a domain controller that comprises a plurality of domain proxy cluster instances. In some embodiments, process 600 may be executed to prevent and/or remedy a cluster fragmentation scenario. In this example, the CBRS domain proxy cluster instance belongs to a cluster of CBRS domain proxy cluster instances. Although the steps of FIG. 6 are described in the context of an example CBRS domain proxy cluster instance, process 600 can be performed by another domain proxy cluster instance without departing from the scope of the disclosed subject matter.

In block 601, the expiration of a transmit expiry time value for a supported CBRS radio device is detected. In some embodiments, a standby domain proxy cluster instance responsible for monitoring (in a non-active standby role) a particular CBRS radio device detects that the radio device's transmit expiry time value has expired or is about to expire. For example, the standby domain proxy cluster instance can be configured to receive transmit expiry time values for each of a plurality of monitored radio devices from one or more active domain proxy cluster instances. The standby domain proxy cluster instance may also be configured to monitor the transmit expiry time values to detect when they expire and/or are not updated by the active domain proxy cluster instance(s).

In block 602, a determination is made as to whether the standby domain proxy cluster instance is able to communicate with both the SAS and the supported radio device. If the domain proxy cluster instance is unable to communicate and/or lost contact with either the SAS or the supported radio device, the process 600 continues to block 603 where the domain proxy cluster instance takes no further action and does nothing.

If the domain proxy cluster instance is (still) able to communicate with both the SAS and the supported radio device, the process 600 continues to block 604 where the transmit expiry time value stored on the monitored radio device is accessed. In some embodiments, the standby domain proxy cluster instance confirms that it can communicate with the SAS and the monitored radio device (e.g., receiving a heartbeat response or ping response). After making this determination, the standby domain proxy cluster instance may access and/or read the current transmit expiry time value stored on the monitored radio device.

After the transmit expiry time value is read, the process 600 continues to block 605 where the standby domain proxy cluster instance determines whether the transmit expiry time value has been updated or not. In some embodiments, the standby domain proxy cluster instance will determine if the transmit expiry time value read from the radio device is still valid (i.e., largely indicative that the transmit expiry time value is being maintained and/or updated by an active standby domain proxy cluster instance) by determining whether the current transmit expiry time value has expired or not. If the transmit expiry time value has been identified by the standby domain proxy cluster instance as being updated, process 600 continues to block 607 where the standby domain proxy cluster instance i) does not attempt to become the active domain proxy cluster instance and ii) continues to function as a proxy cluster instance and continues to monitor the radio device. If the transmit expiry time value is determined to not have been updated, the process 600 continues to block 606 where the standby domain proxy cluster instance determines detects/confirms a cluster fragmentation has occurred (e.g., the communication with the active domain proxy cluster instance and/or communication between the active domain proxy cluster instance and the radio device is lost) becomes the new active domain proxy cluster instance and is configured to initiate the process of updating the transmit expiry time value.

Each of the domain proxy cluster instances deployed by the CBRS domain controller may also be configured to properly share radio device information upon the reformation of the instance cluster (e.g., recovery of domain proxy cluster instance(s) caused by the split brain fragmentation). For example, after the split brain scenario occurs (e.g., a standby domain proxy cluster instance loses its connection/interface to the active domain proxy cluster instance), a network operator may ultimately resolve the problem that is causing the instance cluster fragmentation. When the instance cluster re-forms and/or become re-connected, each individual domain proxy cluster instance is configured to only share information regarding the radio devices that the domain proxy cluster instance is responsible for updating/monitoring. Likewise, the disclosed subject matter will only permit the other domain proxy cluster instance(s) to provide information about the radio devices that the individual domain proxy cluster instance is monitoring. By configuring the domain proxy cluster instances to operate in this manner, the disclosed subject matter is able to prevent the improper collection of radio information and/or ensure that information improperly obtained from radio devices during a split-brain scenario can be disregarded/discarded.

FIG. 7 is a block diagram of a control system 700 according to some embodiments. The control system 700 includes processor circuitry 734, a communication interface 718 coupled to the processor circuitry 734, and a memory 736 coupled to the processor circuitry 734. The processor circuitry 734 may be a single processor or may comprise a multi-processor system. In some embodiments, processing may be performed by multiple different systems that share processing power, such as in a distributed or cloud computing system. The memory 736 includes machine-readable computer program instructions that, when executed by the processor circuit, cause the processor circuit to perform some of the operations and/or implement the functions depicted described herein (e.g., process 600 described above). In some embodiments, the control system 700 may include a network node that hosts a CBRS domain controller, which includes a plurality of domain proxy cluster instances (e.g., active and standby domain proxy cluster instances).

As shown, the control system 700 includes a communication interface 718 (also referred to as a network interface) configured to provide communications with other devices. The network management system 700 also includes a processor circuitry 734 (also referred to as a processor) and a memory 736 (also referred to as memory circuitry) coupled to the processor circuitry 734. According to other embodiments, processor circuitry 734 may be defined to include memory so that a separate memory circuitry is not required.

As discussed herein, operations of the control system 700 may be performed by processing circuitry 734 and/or communication interface 718. For example, the processing circuitry 734 may control the communication interface 718 to transmit communications through the communication interface 718 to one or more other devices and/or to receive communications through network interface from one or more other devices. Moreover, modules may be stored in memory 736, and these modules may provide instructions so that when instructions of a module are executed by processing circuitry 734, processing circuitry 734 performs respective operations discussed herein (e.g., operations associated with process 600 described above) with respect to example embodiments.

Reliability of CBRS for commercial networks is very important. Midband radios are vital for the expansion of 5G into millimeter wave, and the midband spectrum existing in the United States is very scarce. A failure of the CBRS service has the potential to reduce networks to a fraction of their normal transmission capacity.

Experience in the field has shown that the reliability of a clustered CBRS DC depends on its effective operation during a split brain scenario, and its prompt recovery afterwards. The use of sentinels (i.e., one of the industry's “best practices”) may be ineffective in some situations since the cluster members may abandon their tasks if they believe they are isolated from a working cluster. Alternatively, the cluster members may continue their operation when they are isolated and unnecessarily compete with their working cluster.

The disclosed subject matter is configured to determine the cluster status using the confirmed connectivity to the SAS and a supported radio device. Notably, the SAS and radio device will always be available for a cluster member that is capable of performing useful tasks. As such, an isolated cluster member should always be able to identify if other isolated cluster members are working, and share the load with them for as long as the other cluster members are operational.

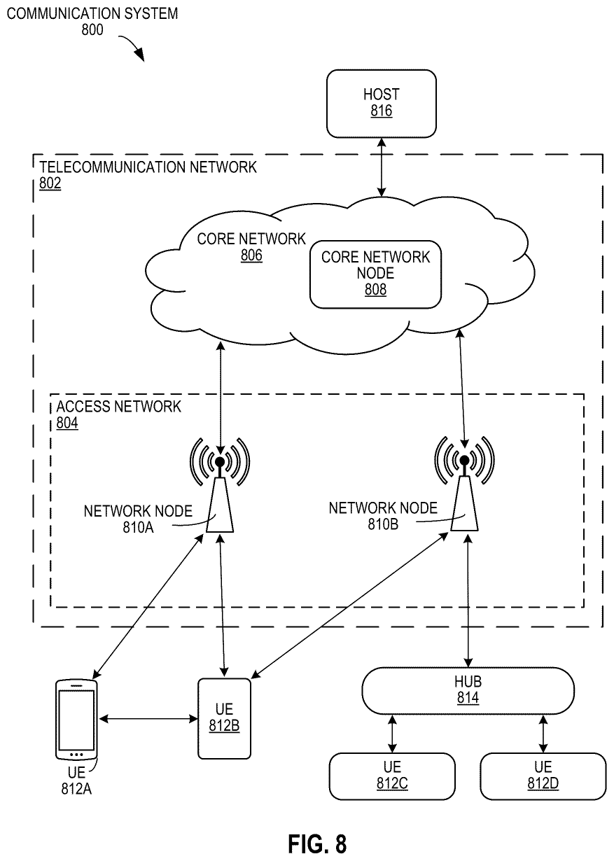

FIG. 8 shows an example of a communication system 800 in accordance with some embodiments.

In the example, the communication system 800 includes a telecommunication network 802 that includes an access network 804, such as a radio access network (RAN), and a core network 806, which includes one or more core network nodes 808. The access network 804 includes one or more access network nodes, such as network nodes 810a and 810b (one or more of which may be generally referred to as network nodes 810), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 802 includes one or more Open-RAN (ORAN) network nodes. An ORAN network node is a node in the telecommunication network 802 that supports an ORAN specification (e.g., a specification published by the O-RAN Alliance, or any similar organization) and may operate alone or together with other nodes to implement one or more functionalities of any node in the telecommunication network 802, including one or more network nodes 810 and/or core network nodes 808.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 810 facilitate direct or indirect connection of user equipment (UE), such as by connecting UEs 812a, 812b, 812c, and 812d (one or more of which may be generally referred to as UEs 812) to the core network 806 over one or more wireless connections. In one embodiment the control system may be implemented in the O-RAN architecture by a Non-Real Time RIC with the control functionality provided by one or more rApps.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include, but not limited to, Mobility Management Entity (MME), Serving Gateway (SGW), Packet Data Gateway (PGW), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), Policy Control Function (PCF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 802 is a cellular network that implements 3GPP standardized features. Accordingly, the telecommunications network 802 may support network slicing to provide different logical networks to different devices that are connected to the telecommunication network 802. For example, the telecommunications network 802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 814 communicates with the access network 804 to facilitate indirect communication between one or more UEs (e.g., UE 812c and/or 812d) and network nodes (e.g., network node 810b). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a VR headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular if one or more of the UEs are low energy IoT devices.

The hub 814 may have a constant/persistent or intermittent connection to the network node 810b. The hub 814 may also allow for a different communication scheme and/or schedule between the hub 814 and UEs (e.g., UE 812c and/or 812d), and between the hub 814 and the core network 806. In other examples, the hub 814 is connected to the core network 806 and/or one or more UEs via a wired connection. Moreover, the hub 814 may be configured to connect to an M2M service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810b. In other embodiments, the hub 814 may be a non-dedicated hub—that is, a device which is capable of operating to route communications between the UEs and network node 810b, but which is additionally capable of operating as a communication start and/or end point for certain data channels.

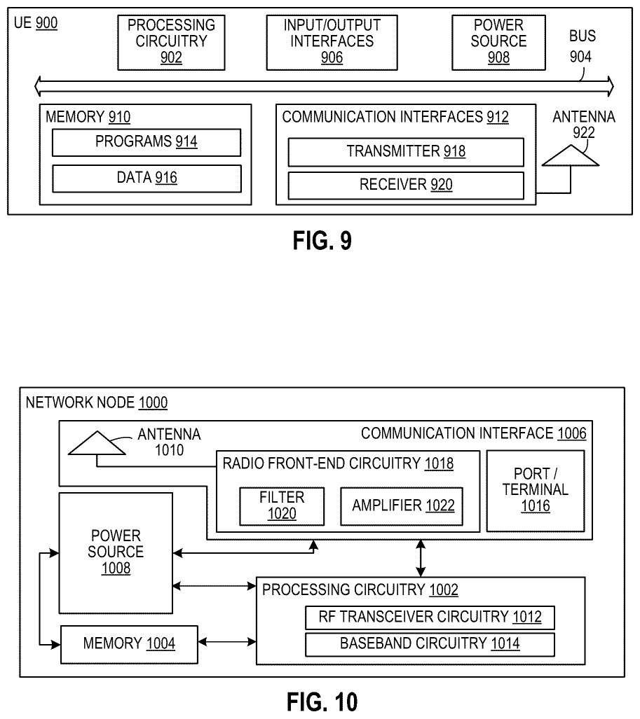

FIG. 9 shows a UE 900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, a memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 902 may include multiple central processing units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging of the power source 908. Power circuitry may perform any formatting, converting, or other modification to the power from the power source 908 to make the power suitable for the respective components of the UE 900 to which power is supplied.

The memory 910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 910 may allow the UE 900 to access instructions, application programs and the like, stored on transitory or non-transitory memory media, to off-load data, or to upload data. An article of manufacture, such as one utilizing a communication system may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., antenna 922) and may share circuit components, software or firmware, or alternatively be implemented separately.

In the illustrated embodiment, communication functions of the communication interface 912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 10 shows a network node 1000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment, eNodeBs, gNodeBs, Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes a processing circuitry 1002, a memory 1004, a communication interface 1006, and a power source 1008. The network node 1000 may be composed of multiple physically separate components, which may each have their own respective components. In certain scenarios in which the network node 1000 comprises multiple separate components (e.g., radio and baseband components), one or more of the separate components may be shared among several network nodes In other embodiments, the network node 1000 may comprise an eNodeBs and/or gNodeB. In some embodiments, the network node 1000 may be configured to support multiple radio access technologies (RATs). In such embodiments, some components may be duplicated (e.g., separate memory 1004 for different RATs) and some components may be reused (e.g., a same antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1000.

The processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1000 components, such as the memory 1004, to provide network node 1000 functionality.

In some embodiments, the processing circuitry 1002 includes a system on a chip (SOC). In some embodiments, the processing circuitry 1002 includes one or more of radio frequency (RF) transceiver circuitry 1012 and baseband processing circuitry 1014. In some embodiments, the radio frequency (RF) transceiver circuitry 1012 and the baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units.

The memory 1004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and memory 1004 is integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. Radio front-end circuitry 1018 comprises filters 1020 and amplifiers 1022. The radio front-end circuitry 1018 may be connected to an antenna 1010 and processing circuitry 1002. The radio front-end circuitry may be configured to condition signals communicated between antenna 1010 and processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of filters 1020 and/or amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface may comprise different components and/or different combinations of components.

In certain alternative embodiments, the network node 1000 does not include separate radio front-end circuitry 1018, instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes one or more ports or terminals 1016, the radio front-end circuitry 1018, and the RF transceiver circuitry 1012, as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, communication interface 1006, and/or the processing circuitry 1002 may be configured to perform any receiving operations and/or certain obtaining operations described herein as being performed by the network node. Any information, data and/or signals may be received from a UE, another network node and/or any other network equipment. Similarly, the antenna 1010, the communication interface 1006, and/or the processing circuitry 1002 may be configured to perform any transmitting operations described herein as being performed by the network node. Any information, data and/or signals may be transmitted to a UE, another network node and/or any other network equipment.

The power source 1008 provides power to the various components of network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid, an electricity outlet) via an input circuitry or interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

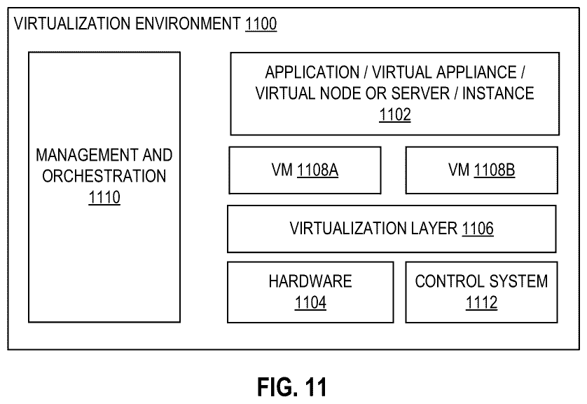

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1100 includes components defined by the O-RAN Alliance, such as an O-Cloud environment orchestrated by a Service Management and Orchestration Framework via an O-2 interface.

Applications 1102 (which may alternatively be called software instances, virtual appliances, network functions, virtual nodes, virtual network functions, etc.) are run in the virtualization environment 1100 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108a and 1108b (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g., such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Embodiments

1. A method performed by a Citizens Broadband Radio Service, CBRS, domain proxy cluster instance for identifying and healing a cluster fragmentation scenario, the method comprising:
detecting (601), by the CBRS domain proxy cluster instance, that a transmit expiry time value for a supported radio device has expired or is about to expire, wherein the CBRS domain proxy cluster instance belongs to a cluster of CBRS domain proxy cluster instances;
determining (602), by the CBRS domain proxy cluster instance, that communications with the supported radio device and a spectrum access system, SAS, are available;
utilizing (604) an interface configured for conducting communications with the supported radio device to access a transmit expiry time value stored on the supported radio device;
determining (605) that an active CBRS domain proxy cluster instance belonging to the cluster has ceased communications with the supported radio device in response to detecting that the current transmit expiry time value stored on the supported radio has expired; and
updating (606) the supported radio device with a new transmit expiry time value.
   2. The method of Embodiment 1, further comprising issuing (606) a request to the SAS for a new transmit expiry time value for the supported radio device.
   3. The method of any of Embodiments 1-2, wherein the CBRS domain proxy cluster instance is a standby CBRS domain proxy cluster instance belonging to a CBRS domain controller.
   4. The method of any of Embodiments 1-3, wherein detecting that the current transmit expiry time value has expired further comprises determining that a time period indicated by the current transmit expiry time value stored locally at the domain proxy cluster instance has expired.
   5. The method of any of Embodiments 1-4, wherein the supported radio device is a CBRS radio device.
   6. The method of any of Embodiments 1-5, further comprising designating, by the CBRS domain proxy cluster instance, itself as an active CBRS domain proxy cluster instance in response to determining that the current transmit expiry time value is expired and has not been updated.
   7. The method of any of Embodiments 1-6, further comprising identifying, by the CBRS domain proxy cluster instance, a cluster fragmentation scenario upon determining that the current transmit expiry time value stored on the supported radio device is expired and has not been updated.
   8. The method of any of Embodiments 1-7, wherein the cluster fragmentation scenario occurs when a communication interface existing between the CBRS domain proxy cluster instance and a current active CBRS domain proxy cluster instance fails, wherein the CBRS domain proxy cluster instance is operating in a standby role.
   9. The method of any of Embodiments 1-8, further comprising requesting, from the SAS by the CBRS domain proxy cluster instance, a new transmit expiry time value for the supported radio device.
   10. The method of any of Embodiments 1-9 further comprising providing, by the CBRS domain proxy cluster instance, the new transmit expiry time value to the supported radio device.
   11. The method of any of Embodiments 1-10, wherein the CBRS domain proxy cluster instance is configured to provide one or more other CBRS domain proxy cluster instances with information associated with the supported radio device in response to the CBRS domain proxy cluster instance reestablishing communication with the one or more other CBRS domain proxy cluster instances and/or the cluster fragmentation scenario being resolved.
   12. A method performed by domain proxy cluster instance for identifying and healing a cluster fragmentation scenario, the method comprising:
detecting (601), by the domain proxy cluster instance, that a transmit expiry time value for a supported radio device has expired or is about to expire, wherein the domain proxy cluster instance belongs to a cluster of domain proxy cluster instances;
determining (602), by the domain proxy cluster instance, that communications with the supported radio device and a spectrum control element are available;
utilizing (604) an interface configured for conducting communications with the supported radio device to access a transmit expiry time value stored on the supported radio device;
determining (605) that an active domain proxy cluster instance belonging to the cluster has ceased communications with the supported radio device in response to detecting that the current transmit expiry time value stored on the supported radio has expired; and
updating (606) the supported radio device with a new transmit expiry time value.
   13. A control system (700) configured for identifying and healing a cluster fragmentation scenario, the control system comprising:
a processing circuit (734); and
a memory (736) coupled to the processing circuit, wherein the memory comprises computer readable program instructions that, when executed by the processing circuit, cause the control system to perform operations according any of Embodiments 1 to 12.
   14. The control system of embodiment 13 wherein the processing circuit and memory are elements belonging to a network node.
   15. The control system of any of embodiments 13-14 wherein the network node hosts a domain controller that comprises a plurality of domain proxy cluster instances.
   16. A computer program comprising program code to be executed by processing circuitry (734) of a network node (700), whereby execution of the program code causes the network node (700) to perform operations according to any of Embodiments 1 to 12.

What is claimed is:

1. A method performed by a Citizens Broadband Radio Service, CBRS, domain proxy cluster instance for identifying and healing a cluster fragmentation scenario, the method comprising:
detecting, by the CBRS domain proxy cluster instance, that a transmit expiry time value for a supported radio device has expired or is about to expire, wherein the CBRS domain proxy cluster instance belongs to a cluster of CBRS domain proxy cluster instances;
determining, by the CBRS domain proxy cluster instance, that communications with the supported radio device and a spectrum access system, SAS, are available;
utilizing an interface configured for conducting communications with the supported radio device to access a transmit expiry time value stored on the supported radio device;
determining that an active CBRS domain proxy cluster instance belonging to the cluster has ceased communications with the supported radio device in response to detecting that a current transmit expiry time value stored on the supported radio has expired; and
updating the supported radio device with a new transmit expiry time value.

2. The method of claim 1, further comprising issuing a request to the SAS for a new transmit expiry time value for the supported radio device.

3. The method of claim 1, wherein the CBRS domain proxy cluster instance is a standby CBRS domain proxy cluster instance belonging to a CBRS domain controller.

4. The method of claim 1, wherein detecting that the current transmit expiry time value has expired further comprises determining that a time period indicated by the current transmit expiry time value stored locally at the domain proxy cluster instance has expired.

5. The method of claim 1, wherein the supported radio device is a CBRS radio device.

6. The method of claim 1, further comprising designating, by the CBRS domain proxy cluster instance, itself as an active CBRS domain proxy cluster instance in response to determining that the current transmit expiry time value is expired and has not been updated.

7. The method of claim 1, further comprising identifying, by the CBRS domain proxy cluster instance, a cluster fragmentation scenario upon determining that the current transmit expiry time value stored on the supported radio device is expired and has not been updated.

8. The method of claim 1, wherein the cluster fragmentation scenario occurs when a communication interface existing between the CBRS domain proxy cluster instance and a current active CBRS domain proxy cluster instance fails, wherein the CBRS domain proxy cluster instance is operating in a standby role.

9. The method of claim 1, further comprising requesting, from the SAS by the CBRS domain proxy cluster instance, a new transmit expiry time value for the supported radio device.

10. The method of claim 1 further comprising providing, by the CBRS domain proxy cluster instance, the new transmit expiry time value to the supported radio device.

11. The method of claim 1, wherein the CBRS domain proxy cluster instance is configured to provide one or more other CBRS domain proxy cluster instances with information associated with the supported radio device in response to the CBRS domain proxy cluster instance reestablishing communication with the one or more other CBRS domain proxy cluster instances and/or the cluster fragmentation scenario being resolved.

12. A control system configured for identifying and healing a cluster fragmentation scenario, the control system comprising:
processing circuitry; and
a memory coupled to the processing circuitry, wherein the memory comprises computer readable program instructions that, when executed by the processing circuitry, cause the control system to perform operations to:
detect, by a Citizens Broadband Radio Service, CBRS, domain proxy cluster instance, that a transmit expiry time value for a supported radio device has expired or is about to expire, wherein the CBRS domain proxy cluster instance belongs to a cluster of CBRS domain proxy cluster instances;
determine, by the CBRS domain proxy cluster instance, that communications with the supported radio device and a spectrum access system, SAS, are available;
utilize an interface configured for conducting communications with the supported radio device to access a transmit expiry time value stored on the supported radio device;
determine that an active CBRS domain proxy cluster instance belonging to the cluster has ceased communications with the supported radio device in response to detecting that a current transmit expiry time value stored on the supported radio has expired; and
update the supported radio device with a new transmit expiry time value.

13. The control system of claim 12 wherein the processing circuitry and memory are elements belonging to a network node.

14. The control system of claim 12 wherein the control system hosts a domain controller that comprises a plurality of domain proxy cluster instances.

15. The control system of claim 12, wherein the control system is further configured to issue a request to the SAS for a new transmit expiry time value for the supported radio device.

16. The control system of claim 12, wherein the control system is further configured to determine that a time period indicated by the current transmit expiry time value stored locally at the domain proxy cluster instance has expired.

17. The control system of claim 12, wherein the CBRS domain proxy cluster instance is further configured to designate itself as an active CBRS domain proxy cluster instance in response to determining that the current transmit expiry time value is expired and has not been updated.

18. The control system of claim 12, wherein the CBRS domain proxy cluster instance is further configured to identify a cluster fragmentation scenario upon determining that the current transmit expiry time value stored on the supported radio device is expired and has not been updated.

19. The control system of claim 12, wherein the CBRS domain proxy cluster instance is further configured to provide the new transmit expiry time value to the supported radio device.

20. A non-transitory computer readable medium storing instructions executable by processing circuitry of a control system, the instructions executed by the processing circuitry to perform operations comprising:
detecting, by a Citizens Broadband Radio Service, CBRS, domain proxy cluster instance, that a transmit expiry time value for a supported radio device has expired or is about to expire, wherein the CBRS domain proxy cluster instance belongs to a cluster of CBRS domain proxy cluster instances;
determining, by the CBRS domain proxy cluster instance, that communications with the supported radio device and a spectrum access system, SAS, are available;
utilizing an interface configured for conducting communications with the supported radio device to access a transmit expiry time value stored on the supported radio device;
determining that an active CBRS domain proxy cluster instance belonging to the cluster has ceased communications with the supported radio device in response to detecting that a current transmit expiry time value stored on the supported radio has expired; and
updating the supported radio device with a new transmit expiry time value.
